(19) United States
(12) Patent Application Publication
(10) Pub. No.: US 2004/0175978 A1
(43) Pub. Date: Sep. 9, 2004

(54) Connector with switching function

(76) Inventors: Toru Mugiuda, Osaka (JP); Narutoshi Hoshino, Osaka (JP); Takeshi Hashimoto, Hyogo (JP); Tadashi Taniguchi, Mie (JP)

Correspondence Address: GREENBLUM & BERNSTEIN, P.L.C., 1950 ROLAND CLARKE PLACE, RESTON, VA, 20191, US

(21) Appl. No.: 10/481,883

(22) PCT Filed: Dec. 25, 2002
(86) PCT No.: PCT/JP02/13482

(30) Foreign Application Priority Data
Dec. 28, 2001 (JP) 2001-401537
Jun. 25, 2002 (JP) 2002-184898

(51) Int. Cl. H01R 29/00

(52) U.S. Cl. 439/188

(57) ABSTRACT

A connector with switching function, for example, used for testing an internal circuit of a mobile telecommunication equipment comprises a stationary contact and a movable contact which are ordinarily contacted, a housing with a contact storage cavity into which the stationary contact and the movable contact are inserted. The housing has an opening through which a center conductor of the probe is inserted so as to contact to the movable contact for switching the connection of the internal circuit. The movable contact is formed in a manner so that a plate spring portion is obliquely elongated toward a lower space of the stationary contact, an extension of the plate spring portion is roundly bent about 180 degrees so as to form a third contacting portion to which the center conductor of the probe is contacted.

### TECHNICAL FIELD

The present invention relates to a connector with switching function which is used, for example, in a mobile telecommunication terminal equipment which transmits radio waves such as a mobile phone.

### BACKGROUND ART

In the mobile telecommunication terminal equipment transmitting radio waves such as the mobile phone, an internal circuit is ordinarily connected to an antenna for transmitting radio waves. For testing whether the internal circuit is normally activated or not, it is necessary to cut off the connection between the internal circuit and the antenna so as not to emit illegal radio waves, and to switch the connection of the internal circuit to a tester. Thus, the connector with switching function is mounted on a circuit board of the mobile telecommunication terminal equipment for switching the connection of the internal circuit to alternative of the antenna and the tester. The connector with switching function is required to be made as smaller as possible for downsizing the mobile equipment.

A conventional connector with switching function, for example, shown in Publication Gazette of Japanese Patent Application 9-245907 is described with reference to FIGS. 36A and 36B.

A probe 170 connected to a tester (not shown) has a ring shaped peripheral conductor 171 and a rod shaped center conductor 172 disposed at a center of the peripheral conductor 171. The peripheral conductor 171 and the center conductor 172 are insulated by an insulator 173. A conventional connector 200 has a stationary contact 240 and a movable contact 220 which are ordinarily connected with each other. When the probe 170 is connected to the connector 200, the center conductor 172 contacts the movable contact 220, so that the connection of the movable contact 220 is switched from the stationary contact 240 to the center conductor 172 of the probe 170.

A housing 202 of the connector 200 is made of an insulation material and has a contact storage cavity 202 with a bottom plate. The movable contact 220 and the stationary contact 240 are respectively press fitted into the contact storage cavity 202a of the housing 202 from sideways in a manner so that contacting portions of them are disposed substantially perpendicular to an insertion direction of the center conductor 172 of the probe 170. A thin ring shaped grounding contact 250 is provided at an upper end of the housing 202, so that the peripheral conductor 171 of the probe 170 is connected to the grounding contact 250 when the probe 170 is connected to the connector 200.

Fitting holes 202b and 202c into which the movable contact 220 and the stationary contact 240 are press fitted are formed at positions on both side walls of the contact cavity 202a of the housing 202 opposing to each other.

The stationary contact 240 is formed for having a substantially J-shaped section by bending a band plate of conductive material, and fixed on the housing 202 by press fitting a contacting portion 240a thereof into the fitting hole 202c of the housing 202. A top end of the contacting portion 240a is protruded into the contact storage cavity 202a, and a contact point 241 is formed on a lower face of the contacting portion 240a of the stationary contact 240.

Similarly, the movable contact 220 is formed for having a substantially J-shaped section by bending a band plate of elastic and conductive material, and fixed on the housing 202 by press fitting a spring portion 220a thereof into the fitting hole 202b of the housing 202. A top end of the spring portion 220a is protruded into the contact storage cavity 202a and elongated toward an opposing side wall over the center of the contact cavity 202a. An upper face in the vicinity of the spring portion 220a facing the contact point 241 of the stationary contact 240 serves as a contact point 221 of the movable contact 220.

The spring portion 220a of the movable contact 220 is biased toward the contacting portion 240a of the stationary contact 240, so that the contact point 221 of the movable contact 220 ordinarily contacts the contact point 241 of the stationary contact 240 by elastic force of the spring portion 220a. Thus, the movable contact 220 is electrically connected to the stationary contact 240. Alternatively, when the probe 170 is connected to the connector 200, the center conductor 172 of the probe 170 proceeds into the contact cavity 202a of the housing 202 and contacts the spring portion 220a of the movable contact 220. The spring portion 220a of the movable contact 220 is pressed in a direction being departed from the contacting portion 240a of the stationary contact 240, so that the contact point 221 of the movable contact 220 is departed from the contact point 241 of the stationary contact 240. Simultaneously, the movable contact 220 is electrically connected to the center conductor 172 of the probe 170, so that a circuit for transmitting electric signals is switched from the stationary contact 240 to the center conductor 172 of the probe 170.

In the above-mentioned conventional connector 200 with switching function, the spring portion 220a of the movable contact 220 is cantilevered on the side wall of the housing 202. Since an effective length of the spring portion 220a, that is, a distance between a fulcrum 224 at which the spring portion 220a is fitted into the fitting hole 202b and a contact point 225 at which the center conductor 172 of the probe 170 is contacted is short about half of the length of the spring portion 220a, the spring portion 220a of the movable contact 220 will be largely warped over elastic limit thereof by contacting of the center conductor 172 of the probe 170. Thus, the spring portion 220a of the movable contact 220 will be plastically deformed, so that a contact pressure between the movable contact point 221 of the movable contact 220 and the stationary contact point 241 of the stationary contact 240 becomes insufficient when the probe 170 is disconnected from the connector 200. The electric connection between the contact point 221 of the movable contact 220 and the contact point 241 of the stationary contact 240 becomes unreliable. For preventing such a problem, it is necessary to make the length of the spring portion 220a of the movable contact 220 longer, so that it causes the limitation of downsizing the connector with switching function.

Especially, the connector with switching function used in the mobile equipment is required to be much smaller, for example, that lengths of the sides are about 2 mm to 3 mm and the thickness of the movable contact is about 0.1 mm to 0.15 mm. Thus, the space allowed for the spring portion of the movable contact in such the contact for the mobile equipment is much shorter. It is difficult to satisfy the incompatible requirements of the downsizing of the connector and the reliability of electric connection between the movable contact and the stationary contact by the conventional configuration of the connector with switching function.

### DISCLOSURE OF INVENTION

An object of the present invention is to provide a connector with switching function which can be downsized without reducing reliability of electric connection between a movable contact and a stationary contact.

A connector with switching function in accordance with an aspect of the present invention comprises a stationary contact and a movable contact which are ordinarily used in contacting state, a grounding contact to which a peripheral conductor of a probe is connected, and a housing made of insulation material and holding the stationary contact and the movable contact. The movable contact is departed from the stationary contact when the probe is connected to the connector.

The housing comprises a contact storage cavity into which the stationary contact and the movable contact are contained so as not to interfere movement of the movable contact, a probe connecting portion to which the probe is connected, and a probe insertion opening through which a center conductor of the probe penetrates from the probe connecting portion to the contact storage cavity.

The stationary contact comprises at least a first fixing portion at which the stationary contact is fixed on the housing, and a first contacting portion protruding in the contact storage cavity.

The movable contact comprises at least a second fixing portion at which the movable contact is fixed on the housing, a plate spring portion obliquely elongated from a front end of the second fixing portion toward a lower space of the first contacting portion of the stationary contact, a second contacting portion formed by roundly bending an extension of the plate spring portion substantially 180 degrees toward the stationary contact so as to be contacted to the first contacting portion of the stationary contact, and a third contacting portion elongated from the second contacting portion toward the second fixing portion to which the center conductor of the probe is contacted.

By such a configuration, the pressing force due to the center conductor of the probe applied to the third contacting portion is transmitted to end of the plate spring portion through the second contacting portion, so that effective length of the plate spring portion becomes substantially the same as the length of the plate spring portion. As a result, the effective length of the plate spring portion of the movable contact of the connector in accordance with the present invention can be made longer than that of the conventional connector. It is possible to prevent the deformation of the plate spring portion of the movable contact due to contacting and departing of the probe. When the effective length of the plate spring portion of the movable contact is made substantially the same as that of the plate spring portion of the movable contact of the conventional connector, it is possible to downsize the connector using the above-mentioned configuration than the conventional connector.

### BRIEF DESCRIPTION OF DRAWINGS

FIG. 1 is a perspective view for showing a test of an internal circuit of a telecommunication equipment such as a mobile phone using a connector with switching function;

FIG. 2A is a conceptual diagram for showing a size and a position of the connector with switching function with respect to the mobile phone;

FIG. 2B is a conceptual diagram for showing electric connection of the connector with switching function when a probe is not connected to the connector;

FIG. 3A is a conceptual diagram for showing the connection of a probe to the connector with switching function;

FIG. 3B is a conceptual diagram for showing electric connection of the connector with switching function when the probe is connected to the connector;

FIG. 4 is a sectional side view for showing a configuration of the connector with switching function and the probe in accordance with a first embodiment of the present invention;

FIG. 5 is a sectional side view for showing a connection state of the connector and the probe in the first embodiment;

FIG. 6A is a side view of the connector in the first embodiment;

FIG. 6B is a front view of the connector in the first embodiment;

FIG. 7 is a perspective view of the connector in the first embodiment;

FIG. 8 is an exploded perspective view for showing the configuration of the connector in the first embodiment observed from the bottom of the connector;

FIG. 9 is an exploded perspective view for showing the configuration of the connector in the first embodiment observed from the top of the connector;

FIG. 10 is a perspective view for showing a detailed shape of a movable contact of the connector in the first embodiment;

FIG. 11 is a perspective view for showing a detailed shape of a movable contact of a connector in accordance with a second embodiment of the present invention;

FIG. 12 is a sectional side view for showing a configuration of a connector with switching function and a probe in accordance with a third embodiment of the present invention;

FIG. 13A is a side view of the connector in the third embodiment;

FIG. 13B is a front view of the connector in the third embodiment;

FIG. 14 is an exploded perspective view for showing the configuration of the connector in the third embodiment observed from the top of the connector;

FIG. 15 is an exploded perspective view for showing the configuration of the connector in the third embodiment observed from the bottom of the connector;

FIG. 16 is an exploded perspective view for showing a configuration of a connector in accordance with a fourth embodiment of the present invention observed from the top of the connector;

FIG. 17 is a sectional side view for showing a configuration of a connector with switching function and a probe in accordance with a fifth embodiment of the present invention;

FIG. 18A is a side view of the connector in the fifth embodiment;

FIG. 18B is a front view of the connector in the fifth embodiment;

FIG. 19 is an exploded perspective view for showing the configuration of the connector in the fifth embodiment observed from the top of the connector;

FIG. 20 is a front view of a base member of a housing with a movable connector of the connector in the fifth embodiment;

FIG. 21 is a perspective view for showing a configuration of the base member of the housing in the fifth embodiment;

FIG. 22 is a sectional side view for showing a configuration of a connector with switching function and a probe in accordance with a sixth embodiment of the present invention;

FIG. 23 is a sectional side view for showing a connection state of the connector and the probe in the sixth embodiment;

FIG. 24 is an exploded perspective view for showing the configuration of the connector in the sixth embodiment observed from the top of the connector;

FIG. 25 is an exploded perspective view for showing the configuration of the connector in the sixth embodiment observed from the bottom of the connector;

FIG. 26 is a perspective view for showing a detailed shape of a movable contact of the connector in the sixth embodiment;

FIG. 27 is a perspective view for showing a detailed shape of a stationary contact of the connector in the sixth embodiment;

FIG. 28 is a sectional side view for showing a configuration of a connector with switching function and a probe in accordance with a seventh embodiment of the present invention;

FIG. 29 is a sectional side view for showing a connection state of the connection of the connector and the probe in the seventh embodiment;

FIG. 30 is an exploded perspective view for showing the configuration of the connector in the seventh embodiment observed from the top of the connector;

FIG. 31 is an exploded perspective view for showing the configuration of the connector in the seventh embodiment observed from the bottom of the connector;

FIG. 32 is a perspective view for showing a detailed shape of a stationary contact of the connector in the seventh embodiment;

FIG. 33 is an exploded perspective view for showing a configuration of a connector in accordance with an eighth embodiment of the present invention observed from the top of the connector;

FIG. 34 is an exploded perspective view for showing the configuration of the connector in the eighth embodiment observed from the bottom of the connector;

FIG. 35 is a perspective view for showing a detailed shape of a stationary contact of the connector in the eighth embodiment;

FIG. 36A is a sectional side view for showing a configuration of a conventional connector with switching function and a probe; and

FIG. 36B is a sectional side view for showing a connection of the conventional connector and the probe.

### BEST MODE FOR CARRYING OUT THE INVENTION

First Embodiment

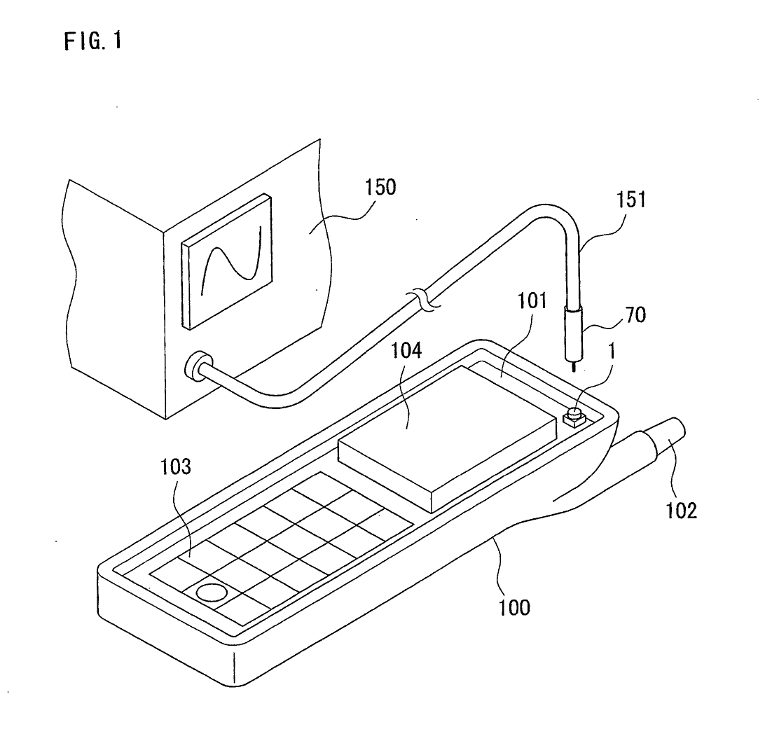

A connector with switching function in accordance with a first embodiment of the present invention is described with reference to FIGS. 1 to 10.

FIG. 1 shows a test of an internal circuit 103 of a mobile phone 100 using a connector 1 with switching function, for example, in a manufacturing process of the mobile phone. The internal circuit 103 of the mobile phone 100 is ordinarily connected to an antenna 102. It is necessary to cut off the connection between the internal circuit 103 and the antenna 102 so as not to emit radio waves while the test of the internal circuit 103. The connector 1 with switching function is provided on a circuit board 101 of the mobile phone 100 between the internal circuit 103 and the antenna 102. A probe 70 which is connected to a tester 150 via a cable 151 is connected to the connector 1 when the internal circuit 103 is tested.

The connector 1 is required to be smaller for downsizing the mobile phone 100, so that the connector 1 is made much smaller, for example, in comparison with a liquid crystal display device 104. An example of dimensions of a product of the connector 1 is 2.7 mm×2.9 mm×1.6 mm.

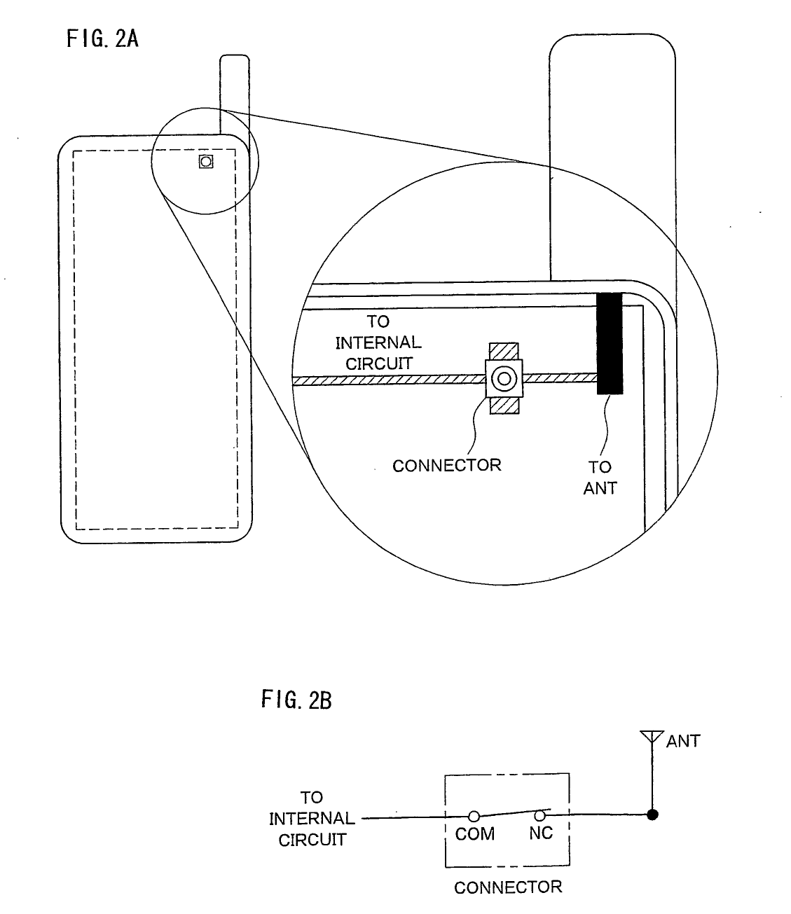

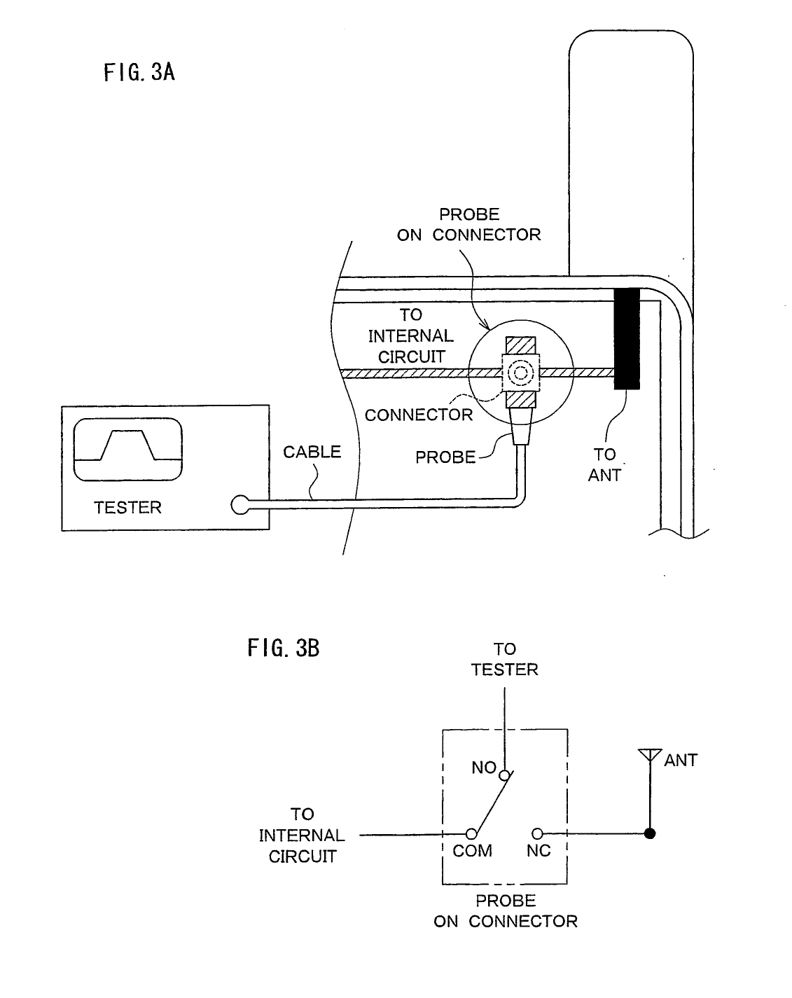

FIG. 2A shows a concept of the connector 1 in ordinarily use for connecting the internal circuit 103 and the antenna 102. FIG. 2B shows electric connection of the connector 1 when the probe 70 is not connected to the connector 1. FIG. 3A shows the concept when the probe 70 is connected to the connector 1. FIG. 3B shows the concept of the switching function of the connector 1 when the probe 70 is connected to the connector 1.

When the probe 70 is connected to the connector 1, the connection between the internal circuit 103 and the antenna 102 is cut off, and the electric connection of the internal circuit 103 is switched from the antenna 102 to the tester 150 through the probe 70.

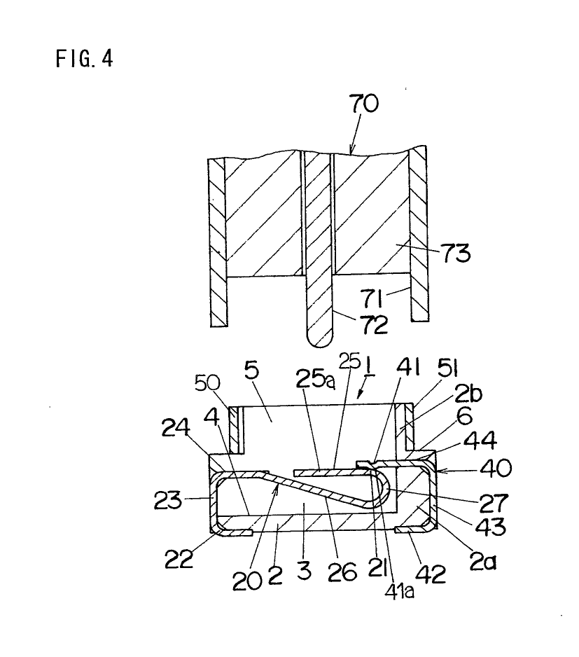

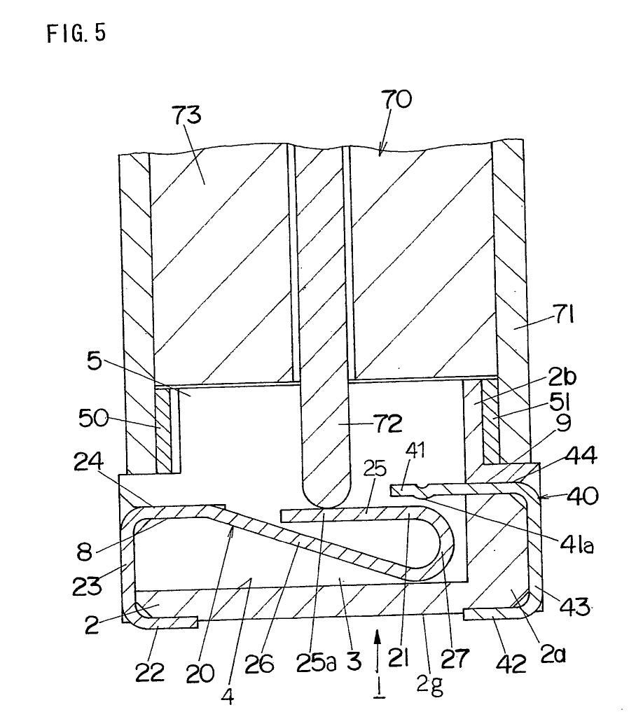

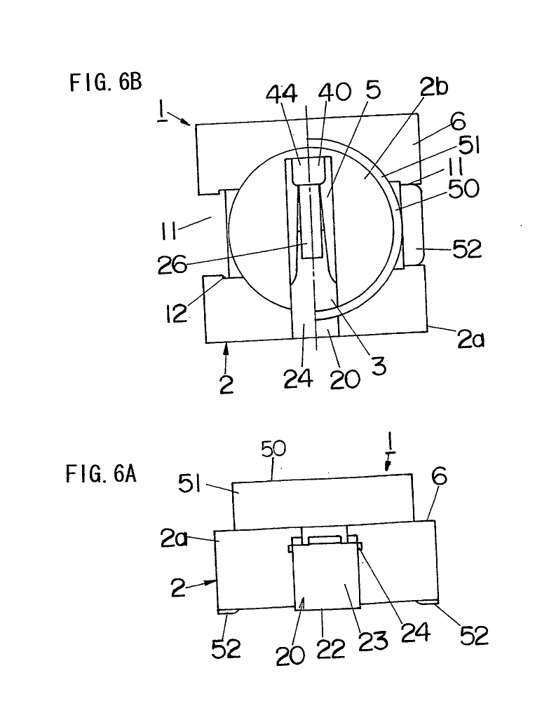

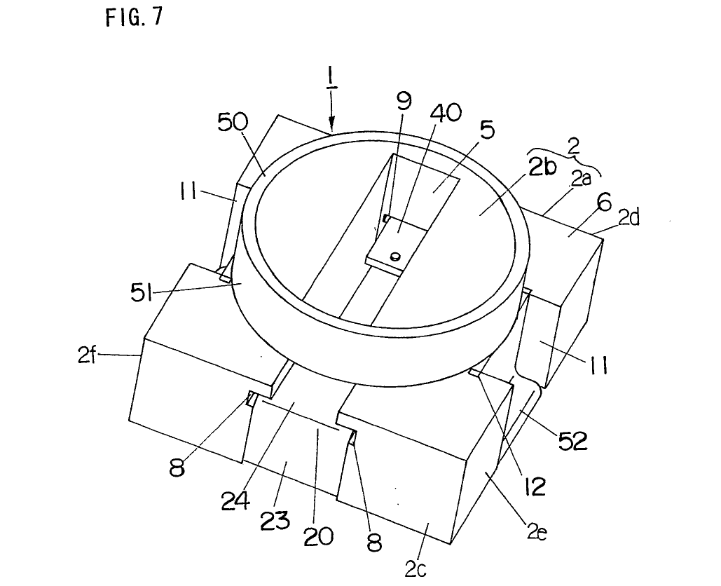

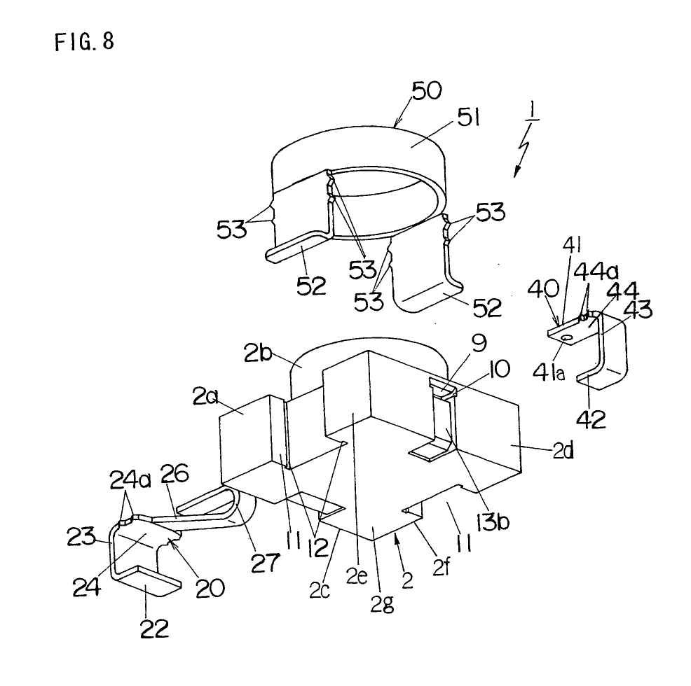

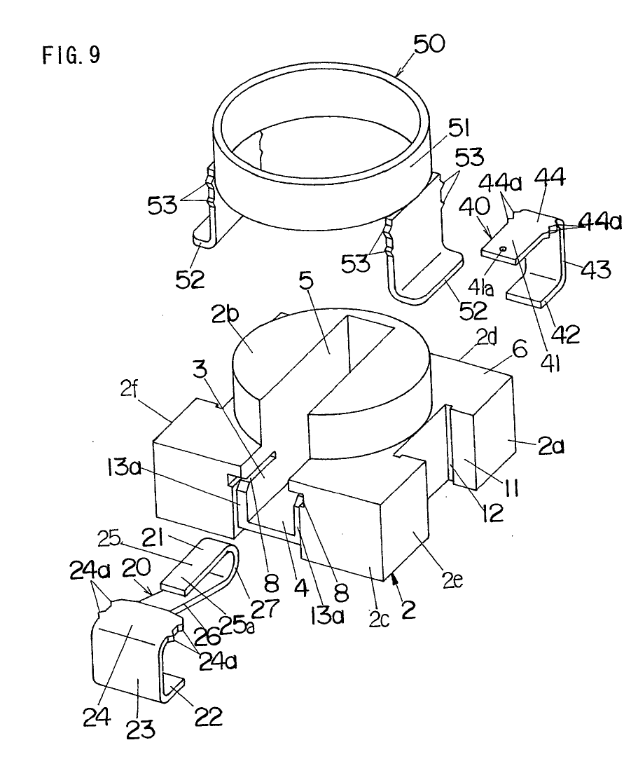

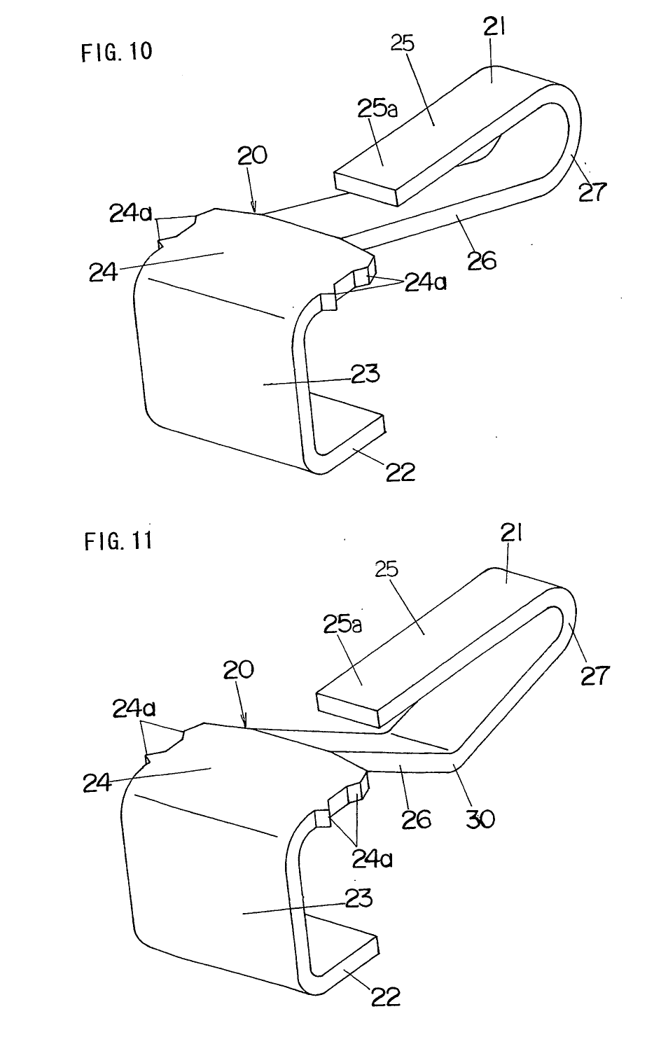

FIG. 4 is a section view showing a configuration of the connector 1 and the probe 70 before connecting the probe 70 to the connector 1. FIG. 5 is a sectional view showing the connection state of the connector 1 and the probe 70. FIG. 6A is a front view of the connector 1. FIG. 6B is a side view of the connector 1. FIG. 7 is a perspective view of the connector 1. FIG. 8 is an exploded perspective view showing the configuration of the connector 1 observed from the bottom side. FIG. 9 is an exploded perspective view showing the configuration of the connector 1 observed from the top side. FIG. 10 is a perspective view showing a detailed shape of a movable contact 20 of the connector 1.

As can be seen from FIGS. 4 and 5, the probe 70 comprises a rod shaped center conductor 72, a cylindrical insulator 73 for holding the center conductor 72 and a ring shaped peripheral conductor 71 which is coaxially held with the center conductor 72 on an outer face of the insulator 73.

As can be seen from FIGS. 4 to 9, the connector 1 comprises a housing 2, a movable contact 20, a stationary contact 40 and a grounding contact 50. The housing 2 is made of an insulation resin such as LCP (Liquid Crystal Polymer), and formed that a substantially cylindrical shaped probe connecting portion 2b is protruded on an upper face of a cuboid base portion 2a.

As can be seen from FIG. 9, a channel shaped contact storage cavity 3 is formed on the housing 2 in a manner so that an opening of the contact storage cavity 3 through which the movable contact 20 is inserted is formed on a side 2c of the housing 2 and a through hole 9 (see FIG. 8) through which the stationary contact 40 is inserted is formed on a side 2d of the housing 2. An upper portion of the contact storage cavity 3 is communicated to a probe insertion opening 5 formed on an upper face of the probe connecting portion 2b through which the center conductor 72 of the probe 70. A pair of fitting grooves 8 to which protrusions 24a of the movable contact 24 are press fitted is formed on both side walls of the contact storage cavity 3 which is opened to the side 2c of the housing 2. Similarly, a pair of fitting grooves 10 to which protrusions 44a of the stationary contact 40 are press fitted is formed on both side walls of the through hole 9 on the side 2d of the housing 2 (see FIG. 8).

As can be seen from FIGS. 6B, 7, 8 and 9, a pair of recesses 11 is formed on both sides 2e and 2f which cross at right angle to the side 2c of the housing 2. Furthermore, a pair of fitting grooves 12 to which protrusions 53 of the grounding contact 50 are press fitted is formed on both side of each recess 11.

The stationary contact 40 is made of a metal having a good conductivity such as phosphor bronze or beryllium copper, and formed by punching and bending a band plate. Thickness of the band plate for the stationary contact 40 is, for example, 0.15 mm. The stationary contact 40 comprises a first contacting portion 41 which will be protruded into the contact storage cavity 3 of the housing 2, a first fixing portion 44 which will be press fitted into the through hole 9, a first spacing portion 43 which is bent at right angle from the first fixing portion 44 and will be disposed along the side 2d of the housing 2, and a first soldering terminal 42 which is bent at right angle from a lower end of the first spacing portion 43 and substantially parallel to the first contacting portion 41. As can be seen from FIGS. 4, 5 and 8, a first contact point 41a is formed to protrude downward on a lower face of the first contacting portion 41 so as to be contacted by the movable contact 20. As can be seen from FIG. 9, two sets of two protrusions 44a are respectively formed on both sides of the first fixing portion 44. In other words, the stationary contact 40 is configured in a manner so that the first contacting portion 41 and the first fixing portion 44 are formed parallel with respect to the first soldering terminal 42 via the first spacing portion 43 formed substantially perpendicular to them.

The movable contact 20 is made of a metal having a good conductivity such as phosphor bronze or beryllium copper, and formed by punching and bending a band plate. Thickness of the band plate for the movable contact 20 is, for example, 0.1 mm. As can be seen from FIGS. 8 to 10, the movable contact 20 comprises a second fixing portion 24 which will be press fitted into the fitting grooves 8 on the housing 2, a second spacing portion 23 which is bent at right angle from a rear end of the second fixing portion 24 and will be disposed along the side 2c of the housing 2, a second soldering terminal 22 which is bent at right angle from a lower end of the second spacing portion 23 and substantially parallel to the second fixing portion 24, a first plate spring portion 26 obliquely elongated from a front end of the second fixing portion 24 toward a lower space of the first contacting portion 41 of the stationary contact 40 when the connector 1 is assembled, a turning portion 27 which is formed by roundly bending the extension of the first plate spring portion 26 substantially 180 degrees toward the stationary contact 40 so as to contact the first contacting portion 41 of the stationary contact 40, a second plate spring portion 25 which is elongated from the turning portion 27 toward the second fixing portion 24. A portion 21 on the second plate spring 25 in the vicinity of the turning portion 27 serves as a second contacting portion and a portion 25a on the second plate spring portion 25 in the vicinity of a free end of the second plate spring portion 25 serves as a third contacting portion. As can be seen from FIG. 9, two sets of two protrusions 24a are respectively formed on both sides of the second fixing portion 24.

In a natural state with no load, the second contacting portion 21 on the second plate spring portion 25 of the movable contact 20 will be positioned above the first contacting portion 41 of the stationary contact 40 when they are independently fixed on the housing 2 so as to generate a predetermined contact pressure. As can be seen from FIG. 4, the second contacting portion 21 on the second plate spring portion 25 of the movable contact 20 contacts the first contact point 41a on the first contacting portion 41 of the stationary contact 40 when the connector 1 is assembled. At this time, the first plate spring portion 26 of the movable contact 20 is warped by contacting the second contacting portion 21 with the first contacting portion 41, so that the predetermined contact pressure is generated.

As can be seen from FIG. 9, the contact storage cavity 3 is widely opened on the side 2c of the housing 2 up to an upper face of the probe connecting portion 2b, so that the movable contact 20 can be inserted into the contact storage cavity 3 of the housing 2 without interfering of the first spring portion 26, the second spring portion 25 and the turning portion 27 with the housing 2. Furthermore, a width of the first plate spring portion 26, the second plate spring portion 25 and the turning portion 27 of the movable contact 20 is made narrower than that of the second fixing portion 24, so that the performance of the first plate spring portion 26 and the second plate spring portion 25 serving as the plate springs can be increased.

The grounding contact 50, to which the peripheral conductor 71 of the probe 70 is contacted, is made of a metal having a good conductivity such as phosphor bronze or beryllium copper, and formed by punching a plate and bending a blank thereof. The grounding contact 50 comprises a ring shaped base shell 51 and a pair of legs 52 elongated from positions opposite to the center of the base shell 51 on a lower end face of the base shell 51. The legs 52 respectively have substantially L-shaped section protruding toward the outside of the base shell 51. Two sets of two protrusions 53 which will be press fitted into the fitting grooves 12 of the housing 2 are formed on both sides of the legs 52.

In order to assemble the connector 1 in the first embodiment, the second fixing portion 24 of the movable contact 20 is press fitted into the fitting grooves 8 of the housing 2 from the side 2c so as to fix the movable contact 20 on the housing 2. Subsequently, the stationary contact 40 is press fitted into the through hole 9 from the side 2d so as to fix the stationary contact 40 on the housing 2, while the second plate spring portion 25 of the movable contact 20 is pushed downwardly. Furthermore, the legs 52 of the grounding terminal 50 are press fitted into the fitting grooves 12 of the housing 2 from upside of the housing 2 and the inner face of the base shell 51 is fitted to the outer face of the probe connecting portion 2b of the housing so as to fix the grounding terminal 50 on the housing 2. Therefore, assemble of the connector 1 is completed.

The widths of the first soldering terminal 42 and the first spacing portion 43 of the stationary contact 40 and the widths of the second soldering terminal 22 and the second spacing portion 23 of the movable contact 20 are made a little wider than the width of the contact storage cavity 3, and positioning recesses 13a and 13b are respectively formed on the sides 2c and 2d of the housing 2 in a manner so that the second spacing portion 23 of the movable contact 20 and the first spacing portion 43 of the stationary contact 40 are respectively fitted into the positioning recesses 13a and 13b. Since the depths of the positioning recesses 13a and 13b are made substantially the same as the thicknesses of the movable contact 20 and the stationary contacts 40, the second spacing portion 23 of the movable contact 20 and the first spacing portion 43 of the stationary contact 40 are respectively contained in the positioning recesses 13a and 13b of the housing 2 in a manner so that the inner faces of the second spacing portion 23 of the movable contact 20 and the first spacing portion 43 of the stationary contact 40 respectively contact the faces of the positioning recesses 13a and 13b of the housing 2. Thus, the movable contact 20 and the stationary contact 40 can be positioned with respect to the housing 2. The base shell 51 of the grounding contact 50 is fitted to the probe connecting portion 2b and the lower face of the base shell 51 contacts an upper face 6 of the base portion 2a of the housing 2 serving as contacting face with the probe 70, so that the grounding contact 50 can be positioned with respect to the housing 2.

When the probe 70 is not connected to the connector 1 as shown in FIG. 4, the second contacting portion 21 of the movable contact 20 contacts the first contact point 41a on the first contacting portion 41 of the stationary contact 40, so that the stationary contact 40 is electrically connected to the movable contact 20. The electric signals such as high frequency signals can be transmitted between the movable contact 20 and the stationary contact 40. The grounding contact 50 is connected to a ground line on the circuit board 101 (see FIG. 1), so that the grounding contact 50 serves as a shield of the housing 2 with respect to the high frequency signals. In the mobile phone 100, high frequency signals are transmitted between the internal circuit 103 and the antenna 102. It is preferable for preventing leakage of noise that the movable contact 20 and the stationary contact 40 by the grounding contact 50.

When the probe 70 is connected to the connector 1 as shown in FIG. 5, the center conductor 72 of the probe 70 contacts the third contacting portion 25a of the movable contact 20, so that the turning portion 27 positioned at the extension of the first plate spring portion 26 of the movable contact 20 is moved toward a bottom 4 of the contact storage cavity 3. Thus, the second contacting portion 21 of the movable contact 20 is departed from the first contact point 41a on the first contacting portion 41 of the stationary contact 40, so that the electric connection of the movable contact 20 is switched from the stationary contact 40 to the center conductor 72 of the probe 70. Simultaneously, the peripheral conductor 71 of the probe 70 contacts the outer face of the base shell 51 of the grounding contact 50, so that the peripheral conductor 71 is electrically connected to the grounding terminal 50. Thus, the circuit board 101 of the mobile phone 100 on which the connector 1 is mounted and the tester 150 can be used the ground commonly. Since the lower end of the peripheral conductor 71 of the probe 70 contacts the upper face 6 of the base portion 2a of the housing 2, excessive insertion of the center conductor 72 of the probe 70 can be prevented.

When the probe 70 is pulled off from the connector 1 after finishing the test of the internal circuit 103, the pressure for pushing the third contacting portion 25a on the second plate spring portion 25 of the movable contact 20 downward is released, so that the movable contact 20 is restored to the initial state shown in FIG. 4 by elasticity of the first plate spring portion 26 and the second plate spring portion 25. Thus, the second contacting portion 21 of the movable contact 20 contacts the first contact point 41a on the first contacting portion 41 of the stationary contact 40, again.

As mentioned above, the movable contact 20 in the first embodiment is configured in a manner so that the first plate spring portion 26 is obliquely elongated from the second fixing portion 24 toward the lower space of the first contacting portion 41 of the stationary contact 40, the extension of the first plate spring portion 26 is roundly bent about 180 degrees toward the first contacting portion 41 for forming the turning portion 27 and the second plate spring portion 25 is formed by extending the turning portion 27 toward the second fixing portion 24. Thus, the pushing force due to the center conductor 72 of the probe 70 applied to the third contacting portion 25a is transmitted to the end of the first plate spring portion 26 through the second plate spring portion 25 and the turning portion 27. As a result, the effective length of the plate spring portion of the movable contact 20 of the connector 1 becomes substantially the same as the length of the first plate spring portion 26. The effective length of the plate spring portion of the movable contact 20 can be made longer than that of the moving contact of the conventional connector. As a result, it is possible to prevent the deformation of the first plate spring portion 26 of the movable contact 20 due to contacting and departing of the probe 70. When the effective length of the first plate spring portion 26 of the movable contact 20 is made substantially the same as that of the plate spring portion of the movable contact of the conventional connector, it is possible to downsize the connector using the above-mentioned configuration than the conventional connector.

Furthermore, the lower faces of the legs 52 of the grounding terminal 50 are formed to be the same level as the lower faces of the first soldering terminal 42 of the stationary contact 40 and the second soldering terminal 22 of the movable contact 20. By such a configuration, the connector 1 can directly be mounted on the circuit board 103 by soldering the lower faces of the soldering terminals 22 and 42 and the legs 52 on circuit patterns printed on the circuit board 103. Furthermore, since the first spacing portion 43 of the stationary contact 40 is tightly fitted into the positioning recess 13b of the housing 2 and the second spacing portion 23 of the movable contact 20 is tightly fitted into the positioning recess 13a, when the connector 1 is soldered on the circuit board 103, soldering flux rarely intrudes into the inside of the contact storage cavity 3 through gaps between the movable contact 20 and the housing 2 and between the stationary contact 40 and the housing 2. Thus, it is possible to prevent the adherence of the soldering flux on the first moving portion 41 of the stationary contact 40 and the second contacting portion 21 of the movable contact 20. Still furthermore, the contact storage cavity 3 has a bottom 4, so that the soldering flux never directly adhere on the first contacting portion 41 of the stationary contact 40 and the second contacting portion 21 of the movable contact 20.

Second Embodiment

A connector with switching function in accordance with the present invention is described with reference to FIG. 11. A configuration of a connector 1 in the second embodiment is substantially the same as that in the above-mentioned first embodiment except the shape of the movable contact 20. FIG. 11 is a perspective view showing a detailed shape of the movable contact 20 of the connector 1. The elements substantially the same as those in the first embodiment are designated by the same numerals and the explanation of them are omitted.

In the first embodiment, the first plate spring portion 26 of the movable contact 20 is straightly elongated toward the lower space of the first contacting portion 41 of the stationary contact 40, and the turning portion 27 is formed at extension of the first spring portion 26. On the other hand, in the second embodiment, the first spring portion 26 of the movable contact 20 is obliquely elongated from the second fixing portion 24 of the movable contact 20 toward substantially the center of the bottom 4 of the contact storage cavity 3, and bent at a bending portion 30 in the vicinity of the bottom 4 of the contact storage cavity 3 upwardly for elongating the first plate spring portion 26 toward the first contacting portion 41 of the stationary contact 40. In other words, the first plate spring portion 26 of the movable contact 20 in the second embodiment has a substantially V-shaped section.

By bending the first plate spring portion 26 of the movable contact 20 for having the V-shaped section, it is possible to make the effective length of the plate spring portion much longer. As a result, it is possible to prevent the deformation of the first plate spring portion 26 of the movable contact 20 due to contacting and departing of the probe 70. When the effective length of the first plate spring portion 26 of the movable contact 20 is made substantially the same as that of the plate spring portion of the movable contact of the conventional connector, it is possible to downsize the connector 1 using the above-mentioned configuration than the conventional connector.

Third Embodiment

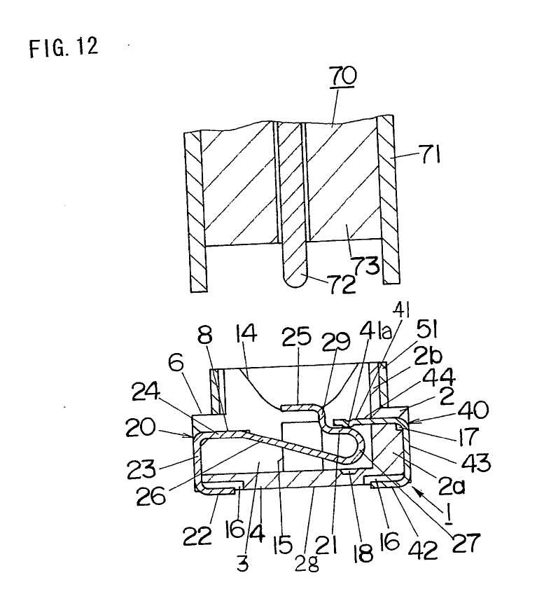

A connector with switching function in accordance with a first embodiment of the present invention is described with reference to FIGS. 12 to 15. A fundamental configuration of a connector 1 in the third embodiment is substantially the same as that in the above-mentioned first embodiment. The elements substantially the same as those in the first embodiment are designated by the same numerals and the explanation of them are omitted.

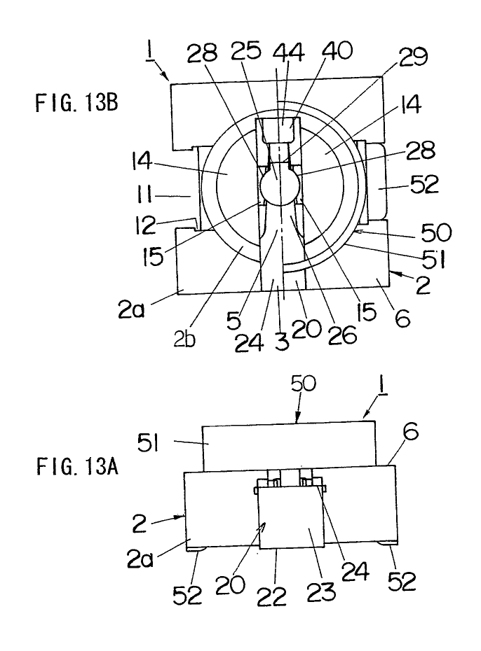

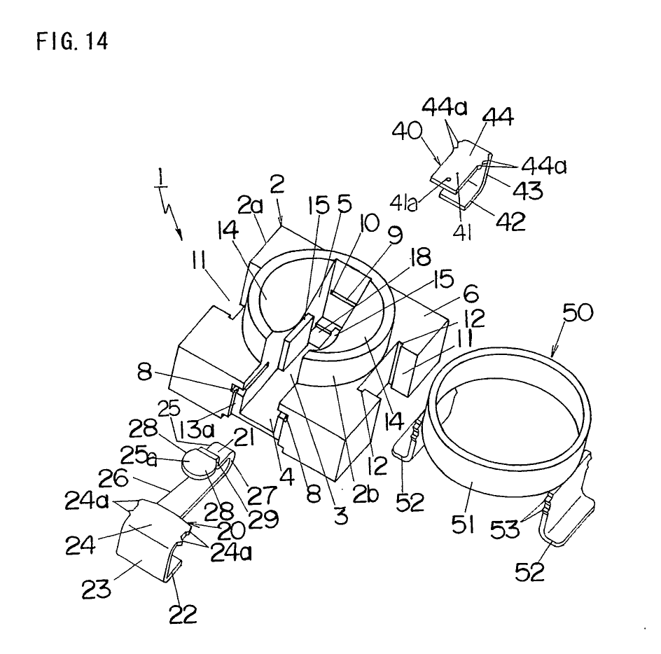

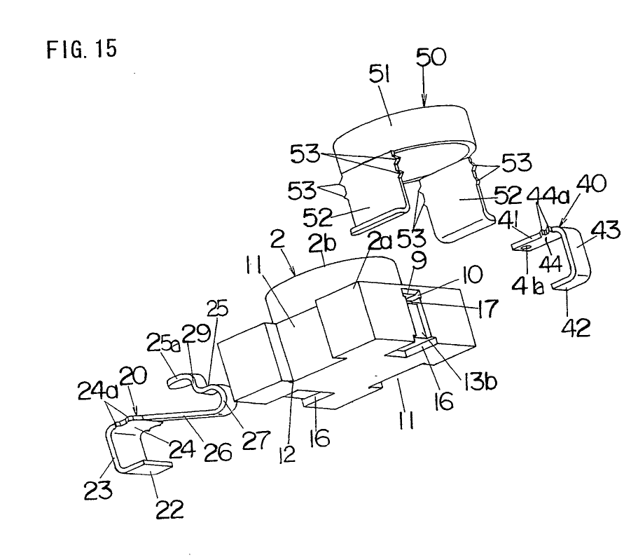

FIG. 12 is a sectional side view showing a configuration of the connector 1 and the probe 70. FIG. 13A is a side view of the connector 1. FIG. 13B is a front view of the connector 1. FIGS. 14 and 15 are an exploded perspective view for showing the configuration of the connector 1.

As can be seen from FIGS. 12 and 15, inclined faces 14 for guiding the insertion of the center conductor 72 of the probe 70 into the contact storage cavity 3 are formed on both side walls of the probe insertion opening 5 by concaving the upper face of the probe connecting portion 2b like a mortar shape. By such a configuration, positioning error of the center conductor 72 against the probe insertion opening 5 can be reduced, since the center conductor 72 moves along the inclined plane 14 when the probe 70 is connected to the connector 1. Thus, the center conductor 72 reliably contacts the third contacting portion 25a of the movable contact 20.

As can be seen from FIGS. 13A, 13B and 14, a pair of round protrusions 28 is formed on both sides of the third contacting portion 25a on the second plate spring portion 25 of the movable contact 20. In other words, the third contacting portion 25a of the movable contact 20 is formed circularly. On the other hand, a pair of stoppers 15 is formed on both side walls of the contact storage cavity 3 opposite to the probe insertion opening 5, to which the protrusions 28 of the third contacting portion 25a of the movable contact 20 will contact when the third contacting portion 25a is pushed down by a predetermined stroke. By such a configuration, it is possible to prevent the plastic deformation of the spring portions 25 and 26 of the movable contact 20 due to the third contacting portion 25a is excessively pushed down due to any trouble such as the excessive insertion of the center conductor 72 of the probe 70.

As can be seen from FIGS. 12, 14 and 15, a crank portion 29 is formed on the second plate spring portion 25 between the second contacting portion 21 and the third contacting portion 25a by bending as crank shape. The third contacting portion 25a of the movable contact 20 is positioned higher than the position of the upper face 6 of the base portion 2a of the housing 2 with respect to the bottom 4 of the contact storage cavity 3. Since the upper face 6 of the base portion 2a of the housing 2 serving as the contacting face with the lower end of the peripheral conductor 71 of the probe 70, the lower end of the center conductor 72 of the probe 70 can be positioned so as not to protrude from the lower end of the peripheral conductor 71 of the probe 70. Thus, the center conductor 72 of the probe 70 can be protected by the peripheral conductor 73, so that the breakage of the probe 70 can be prevented.

As can be seen from FIG. 12, a pair of recesses 16 is formed on the lower face (or outer bottom face) 2g of the housing 2 at positions respectively facing the first soldering terminal 42 of the stationary contact 40 and the second soldering terminal 22 of the movable contact 20 for forming gaps between the soldering terminals 22 and 42 and the housing 2. Furthermore, an offset 17 is formed on an edge between the through hole 9 and the positioning recess 13b of the housing 2 for forming a gap between the housing 2 and the corner of the first fixing portion 44 and the first spacing portion 43 of the stationary contact 40. When the connector 1 is mounted on the circuit board 101 (see FIG. 1) by soldering the soldering terminals 22 and 42 on the circuit patterns printed on the circuit board 101, the melted solder and the soldering flux are pooled in the gaps 16 and 17, so that the soldering flux rarely intrudes into the inside of the contact storage cavity 3 through gaps between the movable contact 20 and the housing 2 and between the stationary contact 40 and the housing 2. Thus, it is possible to prevent the adherence of the soldering flux on the first moving portion 41 of the stationary contact 40 and the second contacting portion 21 of the movable contact 20. Furthermore, it is preferable to form offsets at edges between the fitting grooves 8 and the spacing recess 13a of the housing 2 for forming gaps between the housing 2 and the corner of the second fixing portion 24 and the second spacing portion 23 of the movable contact 20 (which are not illustrated in the figures).

Still furthermore, as can be seen from FIG. 9, a recess 18 is formed on the bottom 4 of the contact storage cavity 3 at a position facing the turning portion 27 of the movable contact 20. When the third contacting portion 25a on the second plate spring portion 25 is pushed down by contacting of the center conductor 72 of the probe 70, the turning portion 27 of the movable contact 20 is not contacted on the bottom 4 of the contact storage cavity 3 owing to the existence of the recess 18, so that the deformation of the movable contact 20 can be prevented. In other words, the quantity of the warping of the first spring portion 26 of the movable contact 20 can be increased by the depth of the recess 18.

Fourth Embodiment

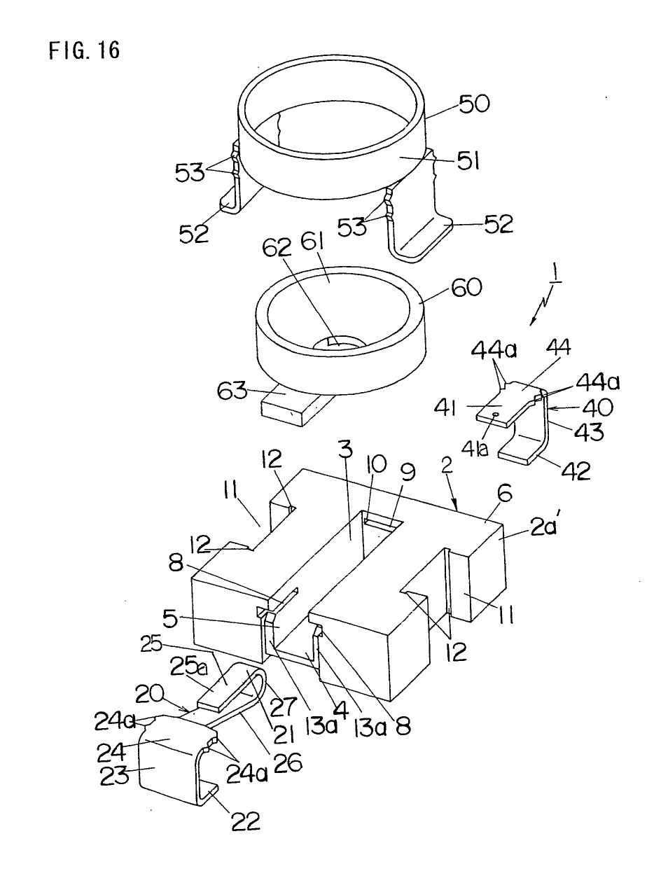

A connector with switching function in accordance with a fourth embodiment of the present invention is described with reference to FIG. 16. FIG. 16 is an exploded perspective view showing a configuration of the connector 1. A fundamental configuration of a connector 1 in the fourth embodiment is substantially the same as that in the above-mentioned first to third embodiments. The elements substantially the same as those in the embodiments are designated by the same numerals and the explanation of them are omitted.

In the above-mentioned first embodiment, the base portion 2a and the probe connecting portion 2b of the housing 2 are integrally formed in one body. In the fourth embodiment, the housing 2 is configured by a base member 2a′ and a probe connecting piece 60 which are independently formed, for example, by molding of insulation resin.

The base member 2a′ has a substantially cuboid shape. As can be seen from FIG. 16, a contact storage cavity 3 for containing the movable contact 20 is formed like a channel shape on the base member 2a′ by cutting the base member 2a′ from a side 2c toward an opposite side 2d.

The probe connecting piece 60 has a substantially cylindrical shape. A probe insertion opening 62 penetrating the probe connecting piece 60 in the axial direction of the cylindrical shape is formed at the center of an upper surface of the probe connecting piece 60. An inclined plane 61 like a mortar shape for guiding the insertion of the center conductor 72 of the probe 70 into the probe insertion opening 62 is formed on the upper face of the probe connecting piece 60. A cover portion 63 fitting to and for covering an upper opening of the contact storage cavity 3 is integrally formed on a lower end of the probe connecting piece 60.

The probe connecting piece 60 is disposed on the base member 2a′ in a manner so that the cover portion 63 is fitted to the upper opening of the contact storage cavity 3, and the legs 52 of the grounding terminal 50 are press fitted into the fitting grooves 12 formed on the base member 2a′,so that the grounding terminal 50 is fixed on the housing 2 and the probe connecting piece 60 and the base member 2a′ are combined.

As mentioned above, the probe connecting piece 60 is separated from the base member 2a′, so that the inclined face 61 for guiding the center conductor 72 of the probe 70 can be formed around the probe insertion opening 62. When the center conductor 72 of the probe 70 is inserted into the probe insertion opening 62 from any direction, the center conductor 72 is certainly guided to the probe insertion opening 62.

Furthermore, the cover portion 63 is integrally formed on the probe connecting piece 60, so that the upper opening of the contact storage cavity 3 is covered by the cover portion 63 when the probe connecting piece 60 is combined to the base member 2a′. Thus, the center conductor 72 of the probe 70 never contacts the grounding terminal 50 or the stationary contact 40. Furthermore, dust rarely intrudes into the contact storage cavity 3. Still furthermore, the cover portion 63 is positioned above the second fixing portion 24 of the movable contact 20 when the connector 1 is assembled, so that the peripheral conductor 71 of the probe 70 never contacts the second fixing portion 24 of the movable contact 20. Thus, the insulation between the peripheral conductor 71 of the probe 70 and the movable contact 20 is assured.

Still furthermore, it is possible integrally to form the probe connecting piece 60 with the grounding terminal 50 by insert molding. By such a configuration, number of parts of the connector 1 can be reduced and the grounding terminal 50 can precisely be fixed on the probe connecting piece 60.

Fifth Embodiment

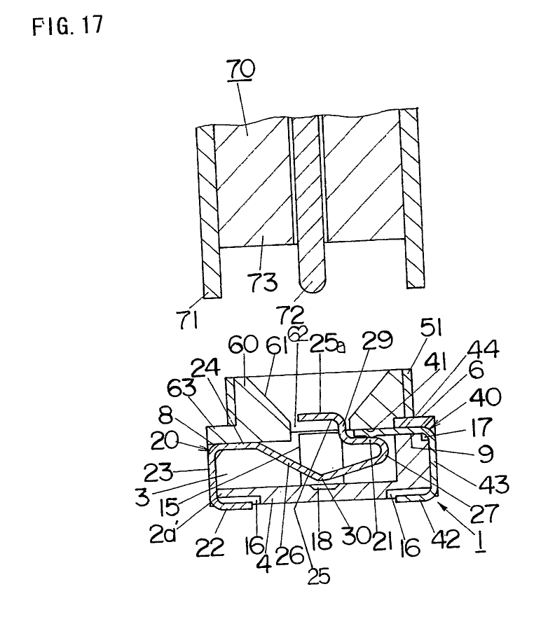

A connector with switching function in accordance with a fifth embodiment of the present invention is described with reference to FIGS. 17 to 21. A fundamental configuration of a connector 1 in the fifth embodiment is substantially the same as those in the above-mentioned first to fourth embodiments. The elements substantially the same as those in the embodiments are designated by the same numerals and the explanation of them are omitted. The fifth embodiment is substantially the combination of the above-mentioned second to fourth embodiments.

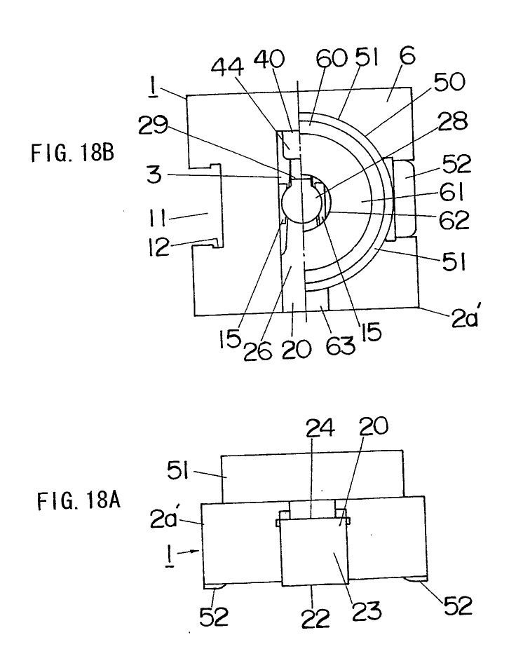

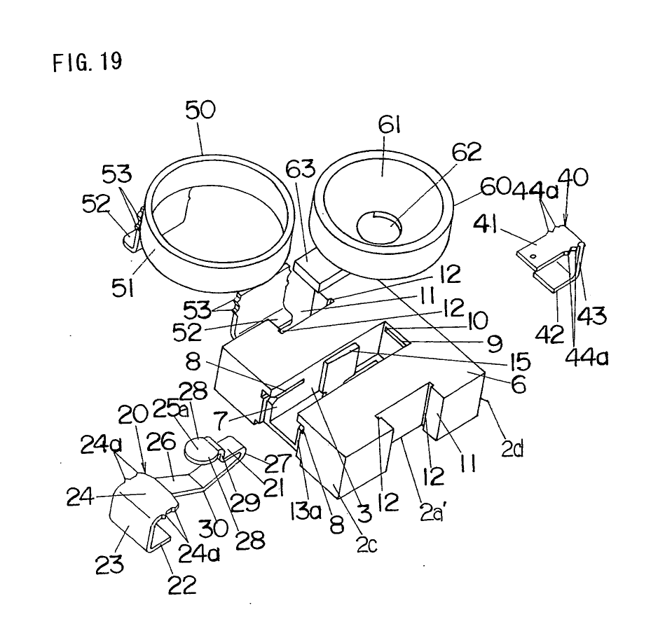

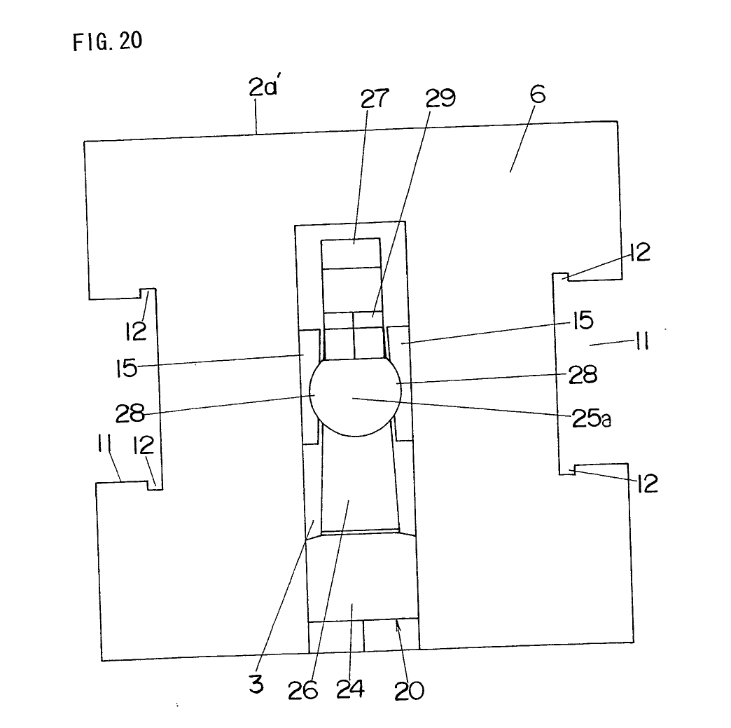

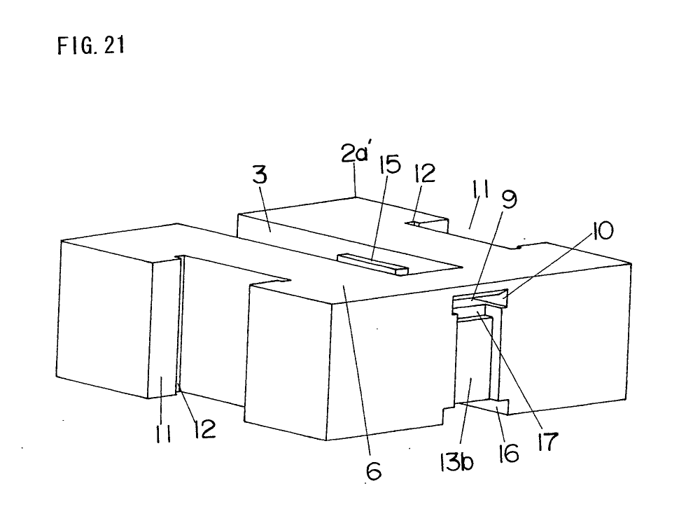

FIG. 17 is a sectional side view showing a configuration of the connector 1 and the probe 70. FIG. 18A is a side view of the connector 1. FIG. 18B is a front view of the connector 1. FIG. 19 is an exploded perspective view showing the configuration of the connector 1. FIG. 20 is a front view of a base member 2a′ of a housing 2 with a movable connector of the connector 1. FIG. 21 is a perspective view showing a configuration of the base member 2a′ of the housing 2.

As can be seen from FIG. 17, the third contacting portion 25a of the movable contact 20 is positioned substantially at the center of the probe insertion opening 62 and above the lower end of the inclined face 61 of the probe connecting piece 60. By such a configuration, the center conductor 72 of the probe 70 certainly contacts the third contacting portion 25a of the movable contact 20.

The first plate spring portion 26 of the movable contact 20 has a substantially V-shaped section by forming the bending portion 30. The recess 18 is formed on the bottom 4 of the contact storage recess 3 at a position facing the bending portion 30. By bending the first plate spring portion 26 of the movable contact 20 for having the V-shaped section, it is possible to make the effective length of the plate spring portion much longer. As a result, it is possible to prevent the deformation of the plate spring portions 25 and 26 of the movable contact 20 due to contacting and departing of the probe 70.

Sixth Embodiment

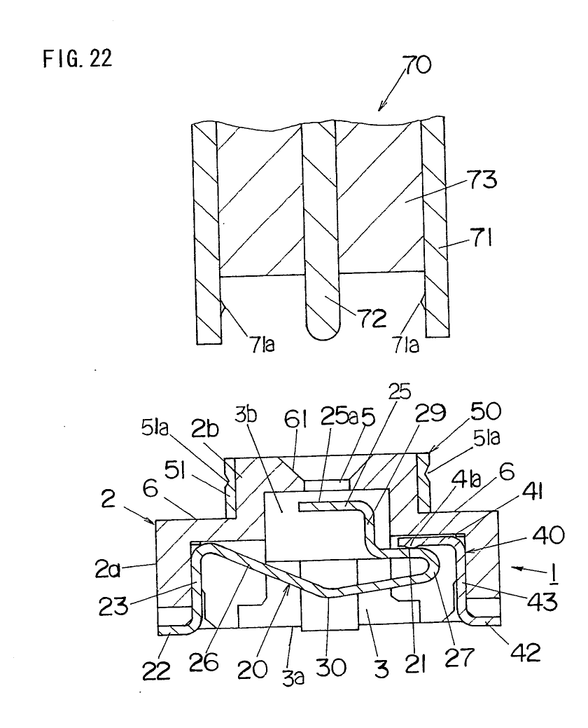

A connector with switching function in accordance with a sixth embodiment of the present invention is described with reference to FIGS. 22 to 27. A fundamental configuration of a connector 1 in the sixth embodiment is substantially the same as those in the above-mentioned first to fifth embodiments. The elements substantially the same as those in the embodiments are designated by the same numerals and the explanation of them are omitted.

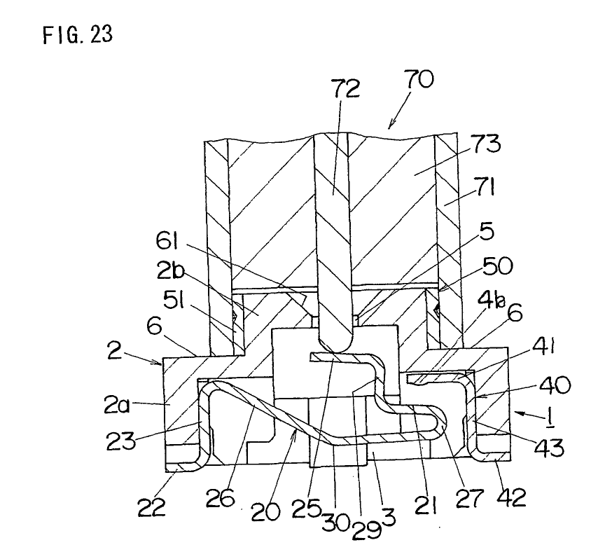

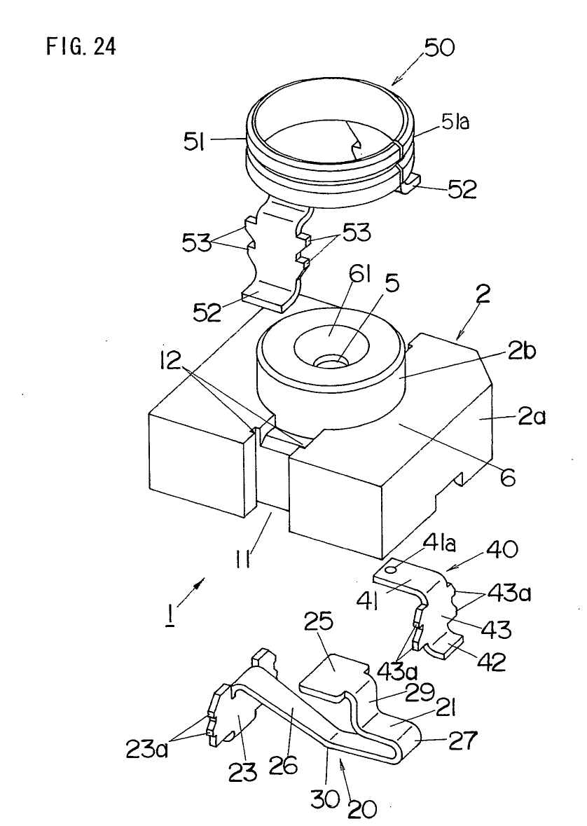

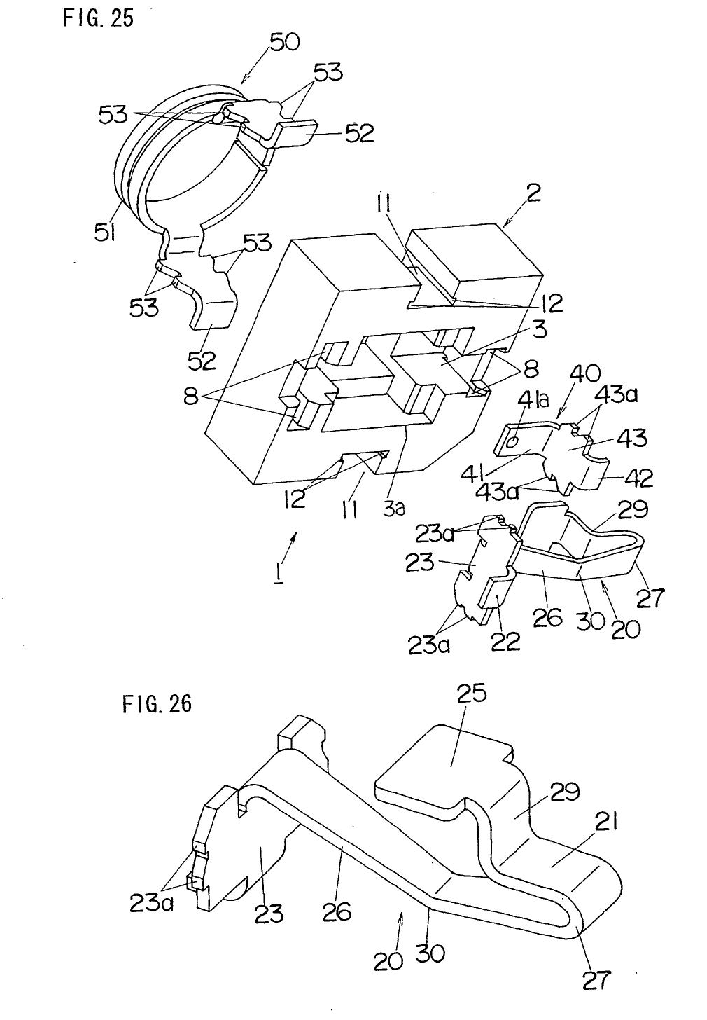

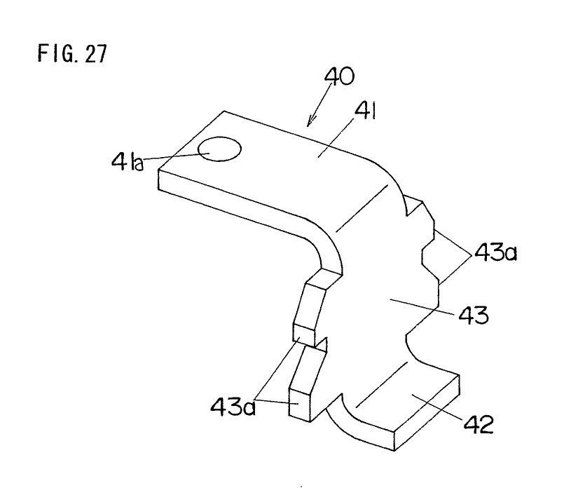

FIG. 22 is a sectional side view showing a configuration of the connector 1 and the probe 70. FIG. 23 is a sectional side view showing a connection state of the connector 1 and the probe 70. FIGS. 24 and 25 are exploded perspective views showing the configuration of the connector 1. FIG. 26 is a perspective view showing a detailed shape of a movable contact 20 of the connector 1. FIG. 27 is a perspective view showing a detailed shape of a stationary contact 40 of the connector 1.

In the above-mentioned first to fifth embodiment, the movable contact 20 and the stationary contact 40 are press fitted into the contact storage cavity 3 of the housing 2 from the sides of the housing 2. In the sixth embodiment, the movable contact 20 and the stationary contact 40 are press fitted into the contact storage cavity 3 of the housing 2 from the bottom of the housing 2.

As can be seen from FIGS. 24 and 25, the housing 2 is made of an insulation resin such as LCP, and formed that the cylindrically shaped probe connecting portion 2b is protruded on an upper face of the cuboid base portion 2a.

As can be seen from FIG. 25, the contact storage cavity 3 has a rectangular opening 3a on the bottom of the housing 2 from which the movable contact 20 and the stationary contact 40 are inserted into the contact storage cavity 3. The movable contact 20 and the stationary contact 40 are aligned in a direction parallel to side having a longer length of the rectangular opening 3a. Two sets of fitting grooves 8 are formed along both sides having a shorter length of the rectangular opening 3a to which the second spacing portion 23 serving as the second fixing portion of the movable contact 20 and the first spacing portion 43 serving as the first fixing portion of the stationary contact 40 are press fitted.

As can be seen from FIGS. 22, 23 and 24, the inclined face 61 like the mortar is formed on the upper face of the probe connecting portion 2b around the probe insertion opening 5. A portion 3b of the contact storage cavity 3 below the probe connecting portion 2b is made narrower corresponding to a diameter of the probe connecting portion 2b.

The stationary contact 40 is made of a metal having a good conductivity such as copper or brass, and formed by punching and bending a band plate. The stationary contact 40 is comprises a first contacting portion 41 which will be protruded into the contact storage cavity 3 of the housing 2, the first spacing portion 43 serving as the first fixing portion which is bent at right angle from the first contacting portion 41, and a first soldering terminal 42 which is bent at right angle from a lower end of the first spacing portion 43 and substantially parallel but opposite to the first contacting portion 41. As can be seen from FIGS. 22, 23 and 25, a first contact point 41a is formed to protrude downward on a lower face of the first contacting portion 41. As can be seen from FIGS. 24, 25 and 27, two sets of two protrusions 43a are respectively formed on both sides of the first spacing portion 43. In other words, the stationary contact 40 is configured to have a substantially crank shape.

The movable contact 20 is made of a metal having a good conductivity such as phosphor bronze or beryllium copper, and formed by punching and bending a band plate. As can be seen from FIGS. 22 to 26, the movable contact 20 comprises the second spacing portion 23 which serves as the second fixing portion, a second soldering terminal 22 which is bent at right angle from a lower end of the second spacing portion 23, a first plate spring portion 26 obliquely elongated from a top end of the second spacing portion 23 toward substantially the center of the contact storage cavity 3 and bent at a bending portion 30 in the vicinity of the bottom of the contact storage cavity 3 upwardly for elongating the first plate spring portion 26 toward the first contacting portion 41 of the stationary contact 40, a turning portion 27 which is formed by roundly bending the extension of the first plate spring portion 26 substantially 180 degrees toward the stationary contact 40 so as to contact the first contacting portion 41 of the stationary contact 40, a second plate spring portion 25 which is elongated from the turning portion 27 toward the second spacing portion 23. As can be seen from FIGS. 24 to 26, two sets of two protrusions 23a are respectively formed on both sides of the second spacing portion 23.

The first plate spring portion 26 of the movable contact 20 in the sixth embodiment has a substantially V-shaped section. By bending the first plate spring portion 26 of the movable contact 20 for having the V-shaped section, it is possible to make the effective length of the plate spring portion much longer.

A portion 21 on the second plate spring 25 in the vicinity of the turning portion 27 serves as a second contacting portion and a portion 25a on the second plate spring portion 25 in the vicinity of a free end of the second plate spring portion 25 serves as a third contacting portion. A crank portion 29 is formed on the second plate spring portion 25 between the second contacting portion 21 and the third contacting portion 25a by bending as crank shape. The third contacting portion 25a of the movable contact 20 is positioned higher than the position of the upper face 6 of the base portion 2a of the housing 2 with respect to the bottom of the contact storage cavity 3.

A ring shaped protrusion 71a is formed on an inner face of the peripheral conductor 71 of the probe 70. An endless recess 51a is further formed on an outer face of the ring shaped cover shell 51 of the grounding contact 50 at a position corresponding to the ring shaped protrusion 71a when the probe 70 is connected to the connector 1. Thus, the probe 70 can firmly be connected to the contact 1 by coupling the ring shaped protrusion in the endless recess 51a.

For assembling the connector 1, the first spacing portion 43 serving as the first fixing portion of the stationary contact 40 is press fitted into the fitting grooves 8 provided at right side of the contact storage cavity 3 in FIG. 25 from the bottom of the housing 2 so as to fix the stationary contact 40 on the housing 2. Subsequently, the second spacing portion 23 serving as the second fixing portion of the movable contact 20 is press fitted into the fitting grooves 2 provided at left side of the contact storage cavity 3 so as to fix the movable contact 20 on the housing 2. Finally, the legs 52 of the grounding contact 50 are press fitted into the guide grooves 12 on the sides of the housing 2 from the upward of the housing 2 so as to fix the grounding contact 50 on the housing 2. Thus, assemble of the connector 1 is completed.

In the sixth embodiment, the contact storage cavity 3 is opened on the bottom of the housing 2, so that there is a possibility that the soldering paste adheres on the first contacting portion 41 of the stationary contact 40 and the second contacting portion 21 of the movable contact 20 when the soldering terminals 22 and 42 are soldered on the circuit patterns printed on the circuit board. The first contacting portion 41 of the stationary contact 40 and the second contacting portion 21 of the movable contact 20, however, are respectively distant from the first soldering terminal 42 of the stationary contact 40 and the second soldering terminal 22 of the movable contact 20 via the first spacing portion 43 and the second soldering portion 23, so that the soldering flux rarely adheres to the first contacting portion 41 and the second contacting portion 21.

Seventh Embodiment

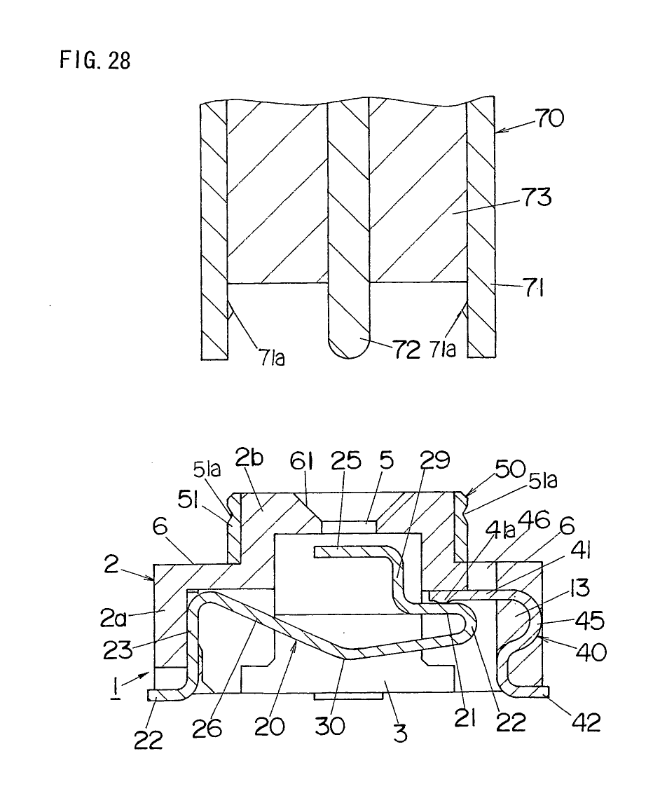

A connector with switching function in accordance with a seventh embodiment of the present invention is described with reference to FIGS. 28 to 32. A fundamental configuration of a connector 1 in the seventh embodiment is substantially the same as those in the above-mentioned first to sixth embodiments. The elements substantially the same as those in the embodiments are designated by the same numerals and the explanation of them are omitted.

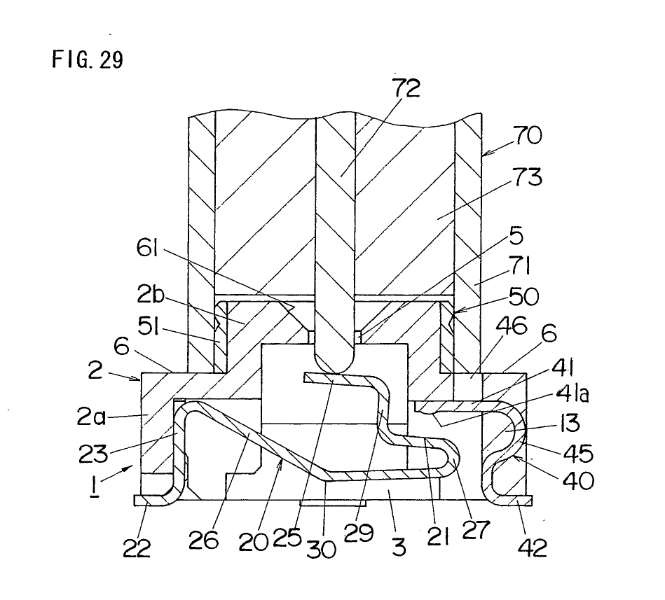

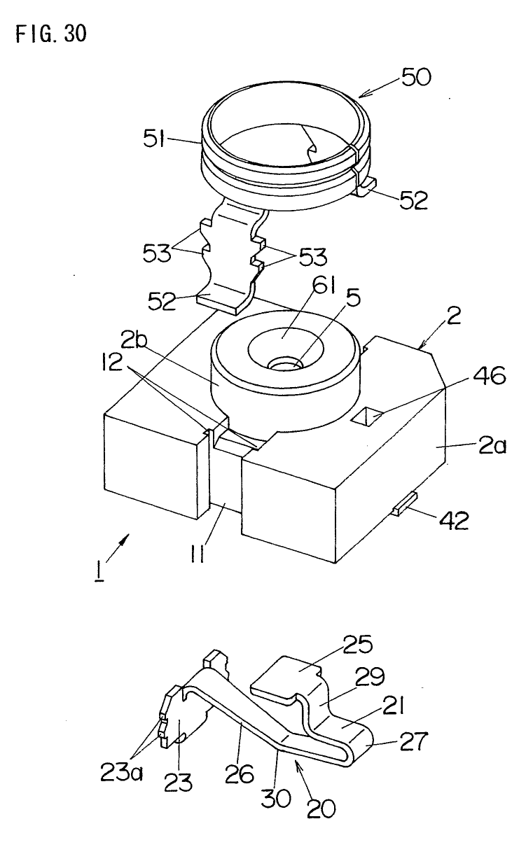

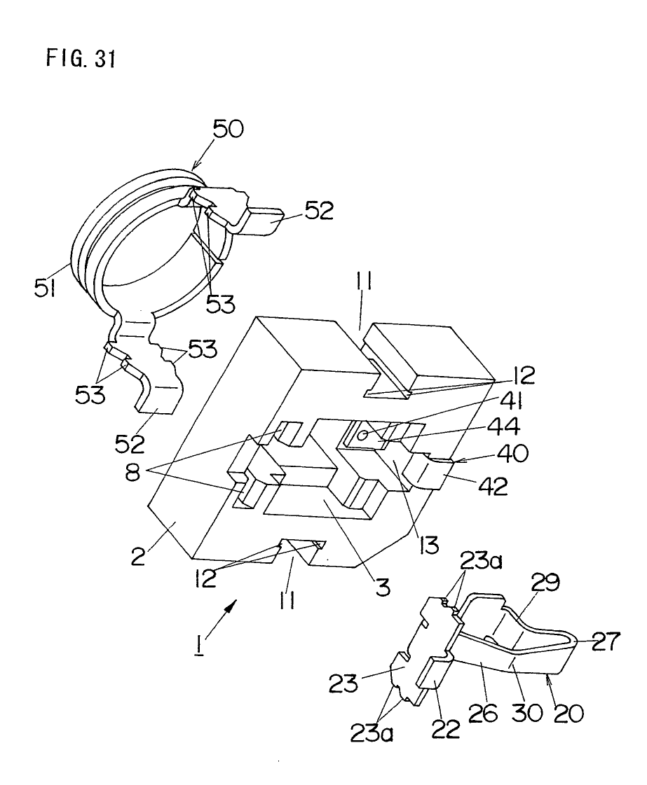

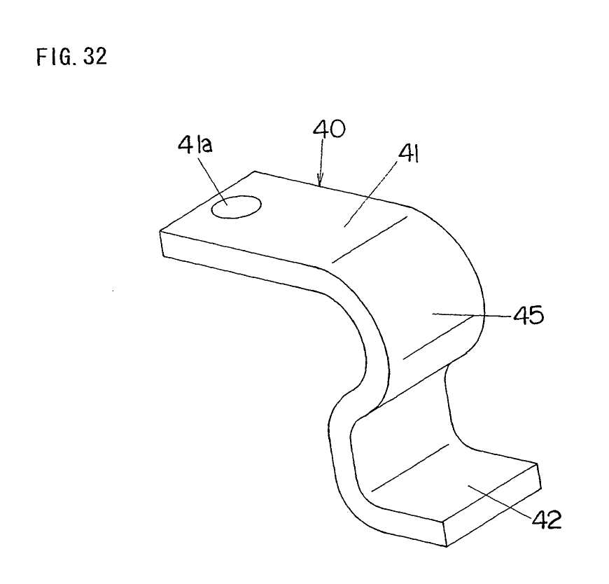

FIG. 28 is a sectional side view showing a configuration of the connector 1 the probe 70. FIG. 29 is a sectional side view showing a connection state of the connection 1 and the probe 70. FIGS. 30 and 31 are exploded perspective views showing the configuration of the connector 1. FIG. 32 is a perspective view showing a detailed shape of a stationary contact 40 of the connector 1.

In the above-mentioned first to sixth embodiments, the stationary contact 40 is press fitted in the housing 2. On the contrary, in the seventh embodiment, the stationary contact 40 is integrally inserted in the housing 2 by the insert molding. As shown in FIGS. 28, 29 and 32, the first contacting portion 41 and the first soldering portion 42 of the stationary contact 40 are connected by a spacing portion 45 serving as the first fixing portion and having S-shaped section. A through hole 46 in FIGS. 28, 29 and 30 is formed for holding the stationary contact 40 in a die while the housing 2 is molded.

By such a configuration, the number of parts of the connector 1 can be reduced, so that assemble of the connector 1 can be simplified. Furthermore, the first contacting portion 41 of the stationary contact 40 and the second contacting portion 21 of the movable contact 20 are separated from the first soldering terminal 42 of the stationary contact 40. Thus, the soldering flux rarely adheres on the first contacting portion 41 of the stationary contact 40 and the second contacting portion 21 of the movable contact 20 by intruding in the contact storage cavity 3 along the first spacing portion 45 of the stationary contact 40.

In the seventh embodiment, whole the S-shaped spacing portion 45 is inserted in the housing 2. It, however, is possible that at least a part of the stationary contact 40 except the first contacting portion 41 and the first soldering portion 42 is inserted in the housing 2.

Eight Embodiment

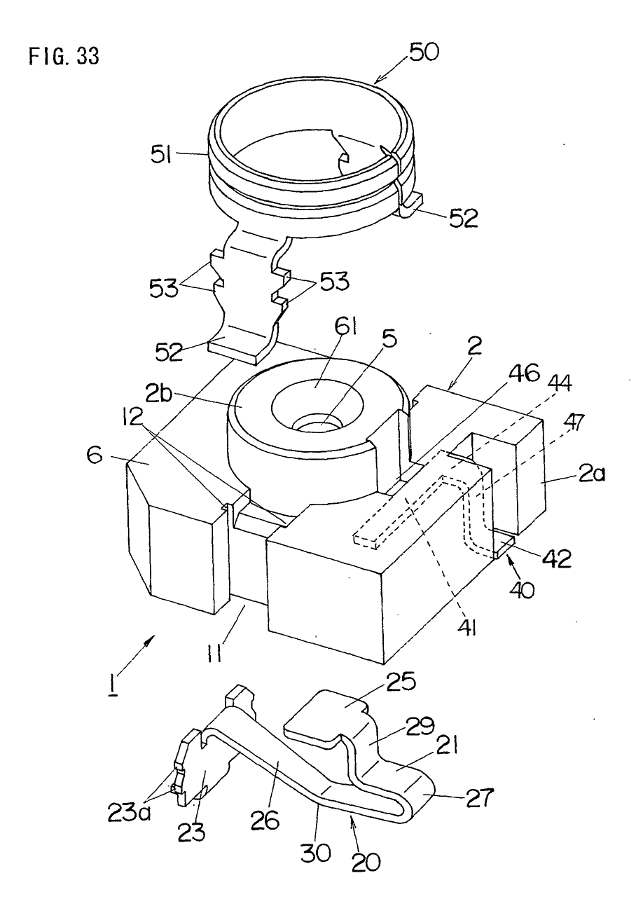

A connector with switching function in accordance with an eighth embodiment the present invention is described with reference to FIGS. 33 to 35. A fundamental configuration of a connector 1 in the seventh embodiment is substantially the same as those in the above-mentioned first to seventh embodiments. The elements substantially the same as those in the embodiments are designated by the same numerals and the explanation of them are omitted.

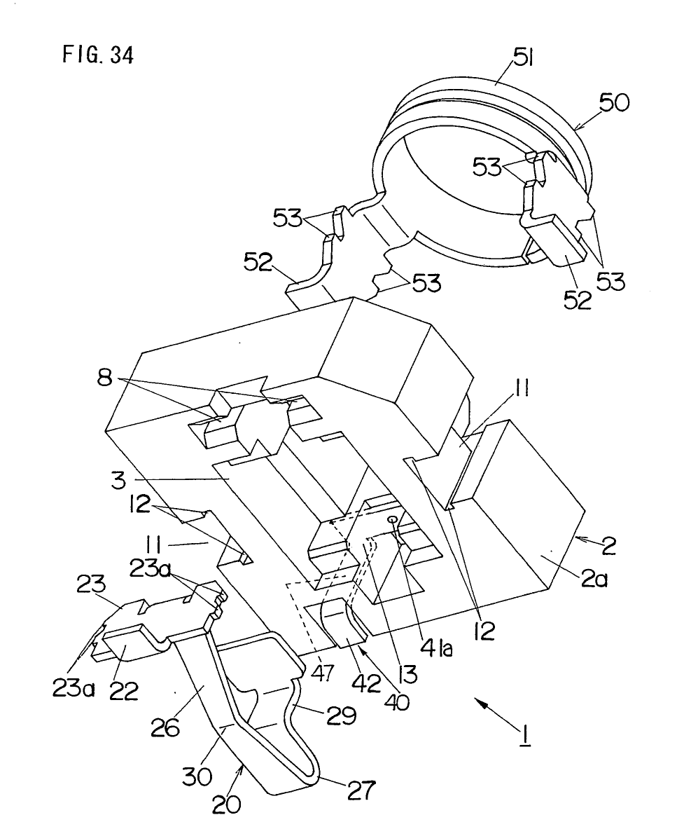

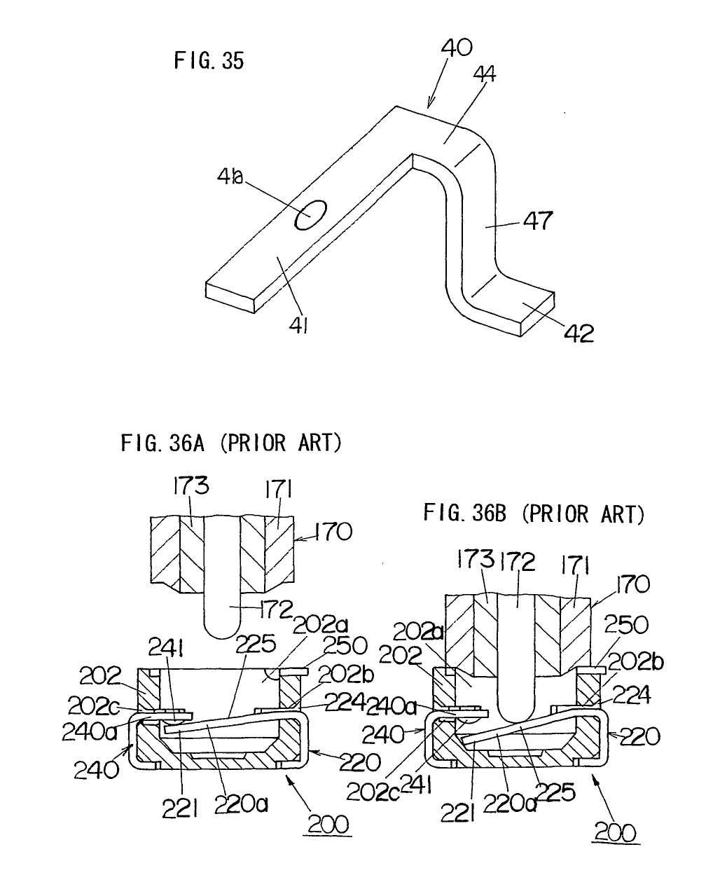

FIGS. 33 and 34 are exploded perspective views showing a configuration of the connector 1. FIG. 35 is a perspective view showing a detailed shape of a stationary contact 40 of the connector 1.

In the eighth embodiment, the stationary contact 40 is inserted in the housing 2. As can be seen from FIGS. 33 and 35, the first contacting portion 41 of the stationary contact 40 is elongated from the first fixing portion 44 in a direction perpendicular to the direction of the elongation of the spring portions 25 and 26 of the movable contact 20. A first spacing portion 47 and the first soldering terminal 42 are offset from the first contact point 41a in the elongating direction of the first contacting portion 41.

By such a configuration, as can be seen from FIG. 34, the first contacting portion 41 in the vicinity of the first contact point 41a of the stationary contact 40 is enclosed by the housing 2 made of the insulation resin, so that the soldering flux rarely adhere on the first contacting portion 41 of the stationary contact 40 and the second contacting portion 21 of the movable contact 20 by intruding in the contact storage cavity 3 along the first spacing portion 47 of the stationary contact 40, much more.

This application is based on Japanese patent applications 2001-401537 and 2002-184898 filed in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A connector with switching function comprising a stationary contact and a movable contact which are ordinarily used in contacting state, a grounding contact to which a peripheral conductor of a probe is connected, and a housing made of insulation material and holding the stationary contact and the movable contact, and the movable contact being departed from the stationary contact when the probe is connected to the connector; wherein
the housing comprises a contact storage cavity into which the stationary contact and the movable contact are contained so as not to interfere movement of the movable contact, a probe connecting portion to which the probe is connected, and a probe insertion opening through which a center conductor of the probe penetrates from the probe connecting portion to the contact storage cavity;
the stationary contact comprises at least a first fixing portion at which the stationary contact is fixed on the housing, and a first contacting portion protruding in the contact storage cavity; and
the movable contact comprises at least a second fixing portion at which the movable contact is fixed on the housing, a plate spring portion obliquely elongated from a front end of the second fixing portion toward a lower space of the first contacting portion of the stationary contact, a second contacting portion formed by roundly bending an extension of the plate spring portion substantially 180 degrees toward the stationary contact so as to be contacted to the first contacting portion of the stationary contact, and a third contacting portion elongated from the second contacting portion toward the second fixing portion to which the center conductor of the probe is contacted.

2. The connector with switching function in accordance with claim 1, wherein
the grounding contact has a substantially ring shape, and the probe connecting portion has a substantially cylindrical shape;
the grounding contact is fitted to an outer face of the probe connecting portion of the housing; and
the probe insertion opening is formed for including a center axis of the probe connecting portion.

3. The connector with switching function in accordance with claim 2, wherein
an inclined face is formed at least a part of around the probe insertion opening on an end face of the probe connecting portion of the housing so as to guide the center conductor of the probe to the probe insertion opening.

4. The connector with switching function in accordance with claim 1, wherein
the contact storage cavity of the housing has a bottom which faces the probe insertion opening; and
the stationary contact and the movable contact are respectively inserted into the contact storage cavity from sides of the housing.

5. The connector with switching function in accordance with claim 4, wherein
a recess is formed on the bottom of the contact storage cavity at a position facing to a bending portion formed by bending an extension of the plate spring portion for forming the second contacting portion of the movable contact so as not to interfere the bending portion with the bottom of the contact storage cavity when the movable contact is warped.

6. The connector with switching function in accordance with claim 1, wherein
the contact storage cavity of the housing has an opening facing the probe insertion opening; and
the stationary contact and the movable contact are inserted into the contact storage cavity from the opening.

7. The connector with switching function in accordance with claim 1, wherein
the housing is configured by the probe connecting piece and a base member independently formed from the probe connecting piece;
the probe insertion opening is formed for including a center axis of the probe connecting piece; and
an inclined face is formed around the probe insertion opening on an end face of the probe connecting piece so as to guide the center conductor of the probe to the probe insertion opening.

8. The connector with switching function in accordance with claim 7, wherein
the probe connecting piece and the grounding terminal are integrally formed by insert molding.

9. The connector with switching function in accordance with claim 1, wherein
a stopper for restricting quantity of movement of the third contacting portion of the movable contact when the center conductor of the probe contacts the third contacting portion of the movable contact is formed on the contact storage cavity.

10. The connector with switching function in accordance with claim 1, wherein
when the second contacting portion of the movable contact contacts to the first contacting portion of the stationary contact, the third contacting portion of the movable contact is protruded outward in a direction of insertion of the center conductor of the probe from a portion on the housing to which an end of the probe contacts.

11. The connector with switching function in accordance with claim 1, wherein
the plate spring portion has at least a bending portion.

12. The connector with switching function in accordance with claim 1, wherein
at least a part of the first fixing portion of the stationary contact is integrally formed with the housing by insert molding.

13. The connector with switching function in accordance with claim 1, wherein
the stationary contact further has a soldering terminal, and the first contacting portion and the soldering terminal are offset from the first contacting portion in a direction perpendicular to both of a direction of alignment of the stationary contact and the movable contact and a direction for inserting the center conductor of the probe.

14. The connector with switching function in accordance with claim 1, wherein
the stationary contact further has a first spacing portion formed by bending substantially at right angle from an end of the first fixing portion opposite to the first contacting portion, and a first soldering terminal to be soldered on a circuit board and formed substantially at right angle from a lower end of the first spacing portion so as to be substantially parallel to the first fixing portion;
the movable contact further has a second spacing portion formed by bending substantially at right angle from an end of the second fixing portion opposite to the plate spring portion, and a second soldering terminal to be soldered on the circuit board and formed substantially at right angle from a lower end of the second spacing portion so as to be substantially parallel to the second fixing portion; and
the housing has recesses for containing the first spacing portion of the stationary contact and the second spacing portion of the movable contact.

15. The connector with switching function in accordance with claim 14, wherein
the first soldering terminal of the stationary contact and the second soldering terminal of the movable contact are respectively bent for facing an outer bottom face of the housing; and
recesses serving as pools of melted solder are formed on the outer bottom face of the housing at positions facing the first soldering terminal and the second soldering terminal.

16. The connector with switching function in accordance with claim 15, wherein
recesses serving as pools of melted solder are formed on portions of the housing facing bending corners between the first fixing portion and the first spacing portion of the stationary contact and between the second fixing portion and the second spacing portion of the movable contact.

17. The connector with switching function in accordance with claim 14, wherein
at least a part of the first fixing portion and the first spacing portion of the stationary contact is integrally formed with the housing by insert molding.

18. The connector with switching function in accordance with claim 14, wherein
the first contacting portion and the first soldering terminal of the stationary contact are offset from the first contacting portion in a direction perpendicular to both of a direction of alignment of the stationary contact and the movable contact and a direction for inserting the center conductor of the probe.

19. The connector with switching function in accordance with claim 1, wherein
high frequency signals are transmitted between the stationary contact and the movable contact.

20. The connector with switching function in accordance with claim 1, wherein
the stationary contact and the movable contact are provided between an antenna and a transmitting and receiving circuit of a mobile transmitting equipment; and
when the transmitting and receiving circuit is connected to a tester, the probe connected to the tester is connected to the connector.
